(19) United States
(12) Patent Application Publication
(10) Pub. No.: US 2003/0020738 A1
(43) Pub. Date: Jan. 30, 2003

(54) Method and device for character input retrieval and indexing

(76) Inventors: Ross William Vinters Milburn, Hong Kong (CN); Caroline Sin Ming Milburn, Hong Kong (CN)

Correspondence Address: BURNS DOANE SWECKER & MATHIS L L P, POST OFFICE BOX 1404, ALEXANDRIA, VA, 22313-1404, US

(21) Appl. No.: 09/916,483

(22) Filed: Jul. 30, 2001

(51) Int. Cl. G09G 5/00

(52) U.S. Cl. 345/700

(57) ABSTRACT

This invention discloses an improved method of inputting a character into an electronic device having a database of characters including the following steps (1) selecting a character element or other characterizing symbol from a plurality of pre-selected symbols, said characterizing symbol being visually similar or equivalent to at least a portion of said character; (2) entering said characterizing symbol into said electronic device by specifying the position, orientation and/or relative size of components of said characterizing symbol by means of two fingers simultaneously tapping in an input grid; and (3) performing steps (1) and (2) a number of times such that the database receives sufficient information to uniquely identify the said character. This invention also discloses a character input device having a substantially square input sensor pad which is adapted to sense two-finger simultaneous tapping for character input.

### FIELD OF THE INVENTION

The present invention relates to methods, devices and apparatus, including keyboards, for inputting and/or retrieving a character into or from an electronic device such as a computer, an information processing system, a search engine and an electronic language processing system. The present invention also relates to a method of inputting or retrieving a character into or from a database of characters. The present invention further relates to a method of indexing or categorizing characters in a database of characters as well as a database of characters having a unique search, indexing or categorizing structure. More specifically, although not solely limiting thereto, the present invention also relates to a novel character input device on which there is provided a sensing grid for a user to place his fingers simultaneously for inputting a characterizing part of the character.

### BACKGROUND OF THE INVENTION

The conventional QWERTY keyboard has been used for 130 years for all languages based on the Roman alphabet. Hundreds of millions of people use the standard keyboard. After a few weeks, most users can input language at a relatively high speed.

In contrast, many methods have been developed to input the Chinese language, and none of them are easy-to-use. High-speed can only be achieved by a relatively small group of individuals, such as those employed in publishing, and then only after very extensive learning. When people input alphabet-based languages, they are free to concentrate on the document being input, and forget about the input process, but when they input Chinese, they must think about the input process.

The economic value of efficient keyboarding is high. Throughout the western world, hundreds of millions of people use the standard keyboard fluently and easily, facilitating the use of both computers and the Internet. Much of the increased productivity achieved in the high-technology industries depends on the widespread ability of the population to employ computer input skills based on the standard keyboard.

The absence of an input method for Chinese that is both easy to learn and fast in operation is a major obstacle to the widespread adoption of information processing systems within China. It follows that the economic value of an efficient and standard input method would be extremely high.

Problems with Existing Methods of Input for Chinese

The majority of language input methods require the user to input an exact code for each word that is to be retrieved. For example, an English keyboard user will input the letters: M-O-T-H-E-R to retrieve the word “mother”. If the user cannot remember the code, the word cannot be correctly retrieved.

In alphabet-based languages, the use of codes is efficient, because there are a small number of letters (26) and users are able to spell most words. For Chinese input, the code method is inefficient, because Chinese characters cannot be broken down into a small and well-known set of constituent components, like the alphabet. Existing Chinese input methods mostly break characters down into a large number of radicals or phonetic components that are difficult to remember and input.

For example, inputting Chinese characters on a standard QWERTY keyboard using conventional input methods such as Cang Jie (Cang Jie “ [symbol] ”) and Ruby (Wu Bi “ [symbol] ”),E the characters must first be broken down into their constituting component parts, which typically include strokes and subordinate characters commonly known as radicals. There are approximately 220 such recognizable components for all commonly used Chinese characters and a greater number if all modern characters are included. In order to enable all such common characters to be entered into a computer, a database processor or other electronic devices through a keyboard, the 220 components need to be fully represented by the keys on a conventional keyboard, of which only about 30 are usually available for language input.

This necessitates a complicated mapping of the 220 components on to the individual keys. Since a combination of keys is needed to represent the individual strokes or radicals, these input methods must necessarily be cumbersome and difficult to learn and memorize. In addition, the analysis of Chinese characters into strokes and radicals requires knowledge in the formation and structure of the Chinese language which is a skill or knowledge probably not possessed by most potential keyboard users.

Another existing input method for Chinese characters requires the user to input the phonetic equivalents (or pinyin “ [symbol] ”) of Chinese characters using a standard keyboard, Pinyin “ [symbol] ” requires a user to have an accurate knowledge of the pronunciation of a particular character, as well as the ability to accurately convert the phonetic equivalence of the pronunciation into the corresponding Roman alphabet. Input systems based on phonetics are difficult to use because the pronunciation of Chinese characters varies greatly in different localities.

Furthermore, even if people can pronounce accurately, they may not be able to transform the pronunciation accurately into the Roman alphabets. In addition, the retrieval of Chinese or other characters on the basis of phonetic resemblance frequently leads to the retrieval of a large number of characters having similar pronunciation which means that a user must examine and review many characters before deciding the correct one to choose.

Some existing input systems that use radicals attempt to make input easier by classifying the radicals on the basis of their structure. For example, in the input method suggested in Chinese patent publication no. CN 1181534A, a user is required to extract the constituting parts of a character and remember the codes representing the constituting elements such as “ [symbol] [symbol] ”. In the proposed method, the constituting parts are generally encrypted by very complicated codes or key stokes representing their structures as well as orientation.

One more example is Chinese patent application no. 98113451.3, published as CN 1227363A, in which it is proposed to use a representative symbol to represent a collection of character components having similar geometric properties. However, such a method still requires the user to accurately identify constituting components of a character in its character form.

The methods of language input that are described above all require the user to input a fixed code for each Chinese character. If the standard keyboard is used, then a fixed sequence of keystrokes much be executed in order to retrieve each character. The input methods try to help the keyboard user to remember the codes for each character, but the process is still extremely difficult, and therefore, on average, slow.

It is therefore desirable that a new character input method and, preferably, an associated input device for non-alphabet based languages is provided so that the difficulties and shortcomings associated with known or conventional character input methods and devices can be alleviated. In achieving the above objectives, the following should be taken into consideration.

(1) Using Boolean Input to Avoid Fixed Codes

Fixed codes are not the only method to retrieve characters from a database. Another method is the use of Boolean logic, which means a rule-based system in which the keyboard user inputs information about the attributes of the desired character until the computer has sufficient information to make a unique identification of the character. In this kind of input system, the sequence in which the attributes are entered does not affect the retrieval process. However, even when a Boolean input method is used to enter Chinese on the standard keyboard, the process is still slow. This is because the character attributes that are input are complex shapes that have to be remembered.

(2) Develop a New Chinese Input Deice

Many of the difficulties associated with inputting non alphabet-based languages such as Chinese arise because of the use of the standard QWERTY keyboard, that was designed for alphabet based input. The proposed invention should provide an input device and input method optimized for the input of Chinese and similar non alphabet-based languages.

(3) The Use of Character Appearance for Input

In order to input language, users must always enter information to the input device. When users input English or other alphabet-based languages, they use their knowledge of spelling, because this system is easy to use. When users input Chinese characters on the same standard keyboard, they are forced to use information about radicals, or pronunciation, which are much more complicated than spelling. Even if their input method uses some information of character geometry, it is difficult to input because the keyboard is not designed for that purpose.

### OBJECT OF THE INVENTION

It is an object of the present invention to address the need for a new and dedicated character input system and input device for languages that do not use an alphabet, such as Chinese.

It is also an object of the present invention to provide, for Chinese and other languages not based on an alphabet, an input method and a device that are easier to learn and use than existing methods. In particular, the object is to provide an input method that is preferably based upon the appearance of characters, rather than, for example, the user's knowledge of radicals, or phonetic pronunciation.

Furthermore, it is an object of the present invention to provide an input method and an input device for non-alphabet-based languages that enable users to achieve high character input speeds without the need for an extended learning period. In particular, the object is to utilise “natural” human hand gestures comprising simultaneous movement of multiple fingers, to input character elements of characters more rapidly than by using the less natural finger movements of the standard QWERTY keyboard. Additionally, the object is to use modern sensor technology to record these movements efficiently.

A further objective is to provide an input device suitable for any user who knows the appearance of the characters to be input. In contrast, existing methods of input are intended for specific users groups, because they are based on specialised knowledge of the language, such as pronunciation, stroke order, or radical analysis.

### SUMMARY OF THE INVENTION

According to a first aspect of the present invention, there is disclosed a method of inputting a character into an electronic device having a database of characters including the following steps:

(1) selecting a characterizing symbol of said character from a plurality of pre-selected symbols, said characterizing symbol being visually similar or equivalent to at least a portion of said character;

(2) entering said characterizing symbol into said electronic device by specifying the position, orientation and/or relative size of components of said characterizing symbol;

(3) performing steps (2) and (2) one or more times until said character has been selected.

Preferably, the characterizing symbol is entered into said electronic device though a substantially square input grid.

Preferably, the physical characteristics including the relative size of components, position and/or orientation of said characterizing symbols are input with reference to a grid in which the character to be selected is squarely fitted.

Preferably, the method includes search by a processing means for characters having said symbol and said physical characteristics of said symbol.

According to another aspect of the present invention, there is provided a method of inputting a character into an electronic device having a database of characters including the following steps:

(1) selecting a character element or other characterizing symbol from a plurality of pre-selected symbols, said characterizing symbol being visually similar or equivalent to at least a portion of said character;

(2) entering said characterizing symbol into said electronic device by specifying the position, orientation and/or relative size of components of said characterizing symbol by means of two fingers simultaneously tapping in an input grid; and

(3) performing steps (1) and (2) a number of times such that the database receives sufficient information to uniquely identify the said character.

Preferably, the characterizing symbol is entered into said electronic device through a square input grid at a location and orientation relative to the square grid that is identical to the location and orientation of the character element relative to the said character.

Preferably, the input grid bears a grid of lines intended to assist the user in locating his hand during input.

Preferably, the said characterizing symbols can be defined by using two definitive points on said input grid. Entering said characterizing symbol into said electronic device by specifying the position, orientation and/or relative size of components of said characterizing symbol by means of two fingers simultaneously tapping in an input grid.

Preferably, further including adjusting the aspect ratio of a character to near unity for specifying its physical characteristics both in the database and in the input grid.

Preferably, the method includes search by a processing means for characters having said symbol and said physical characteristics of said symbol.

According to yet another aspect of the present invention, there is provided a character input device for an electronic device including a plurality of input selections corresponding to a plurality of input selectable character symbols and an input grid on which the relative size, orientation and/or position of said selected symbol can be defined and input into said electronic device.

Preferably, the selectable characterizing symbols include one or some of the following symbols:

[symbol]

[symbol]

Preferably, the input grid includes a square panel having associated with it the means of detecting the locations of two simultaneous finger touches on its surface.

Preferably, the selected characterizing symbol can be entered through the input grid by means of two fingers simultaneously tapping in an input grid.

Preferably, the identify of the symbol as well as the associated physical characteristics are sent from said device to an electronic processing means.

Preferably, the input grid includes a touch-type sensor pad.

### BRIEF DESCRIPTION OF THE DRAWINGS

Preferred Embodiments of the present invention will now be explained by way of examples and with reference to the accompanying drawings in which:

FIG. 1 illustrates a preferred layout of a device for character input or retrieval provided with six selection keys for the symbols (1) of FIGS. 2a-2f as well as a multi-touch input grid (2) for specifying the location of each character element within the tablet and a cable (3) connected to the keyboard port of a computer;

FIGS. 2a-2f shows six symbols that represent a preferred selection of geometric elements of Chinese characters suitable for use in the present invention;

FIGS. 3a-3f shows examples of the geometric elements FIGS 2a-2f taken from Chinese characters, and the corresponding defining points used to specify the position, size and angle of the elements;

FIG. 4 illustrates a further example of a character indicating a plurality of character elements which can be identified in the character and used for input purposes;

FIGS. 5a-5b show a narrow character “ [symbol] ” illustrating the adjustment of its aspect ratio in the database so the whole area of the input tablet can be used to input its geometric attributes;

FIG. 6 shows an example of a character “ [symbol] ” illustrating the present invention;

FIGS. 7a-7d show any example of a character “ [symbol] ” illustrating the two character elements used to input this character. For each character element the user presses a key with the correct symbol, then taps the input grid simultaneously with two fingers to input the location of the elements in the character;

FIG. 8a shows the character of FIG. 7 and indicates the portion of the character which is to be specified by using the present preferred method into an electronic device by utilizing the character element “ ”;

FIG. 8b shows the user selecting the character element “ ” appropriate for representing the selected portion of FIG. 8a and inputting the symbol into the electronic device by using a single finger, namely, the left-hand thumb;

FIG. 8c shows an user specifying the two location points of the defining portion of the character element;

FIG. 9 is a flow chart illustrating the simplified logic steps in connection with the preferred character input and retrieval method.

### DETAILED DESCRIPTION OF THE PREFERRED EMBODIMENTS

In the proposed invention, a new input device that has been optimised for Chinese and other non alphabet-based languages will be described. The information input relates substantially to the visual appearance of the Chinese characters and generally comprises a small set of common geometrical elements. These elements are extremely easy to use, because each user of Chinese has already learned to write the strokes of each character. All Chinese input users will have this information of character geometry respective of age, expertise, literacy, education or intelligence.

(1) Use of a Input Grid to Input Geometry

In order to make it easy to enter geometrical information about characters, the input device of the current invention preferably incorporates a square panel capable of detecting two simultaneous finger touches. Since Chinese characters are also approximately square, the input device user can input to this input grid elements of any Chinese character in the same location, size and angle as they appear in the original character.

The area of the input grid is preferably completely used for input, so that the character is always input as if it occupied the total area of the panel, from top to bottom and from left to right. This means that information input by the user can show very accurately the location, size and angle of elements of the character's structure.

(2) Use of Multiple Simultaneous Finger Taps

In order to achieve a rapid rate of character input, a new method of entering data is desirable. In the proposed method, two fingers are simultaneously tapped on the input grid, to input the coordinates of character elements.

The use of two fingers to simultaneously tap on the input grid greatly increases the amount of information input to the computer. For example, if the user tops one finger on a input grid, he may choose from thousands of locations. If he taps two fingers simultaneously, he is choosing from millions of combinations of locations. Compared to using keystrokes on the standard QWERTY keyboard, when two fingered tapping on a input grid is used, much more information is input, and characters are retrieved more quickly.

The two-fingered tapping proposed in this invention is based on a natural form of human communication, the use of hand gestures. This input method is easier to learn than the somewhat unnatural ten-fingered method used to operate the standard keyboard

(3) Choice of Character Elements

Chinese characters have a large variety of attributes that can be input, because many character are complex structures. In order to achieve high-speed character input the choice of shapes have been made according to design requirements as indicated below.

1. Must be a small set. In the current invention, only six character elements are used, and they are selected by the fingers of one hand. If a large number of character elements were used, the input speed would be slower.

2. Must occur frequently among all Chinese characters. This input device requires input of at least two attributes to retrieve each character. Therefore, the character elements selected must occur so frequently in Chinese characters that there are at least two of them present in nearly every character.

3. Must vary a lot in location and orientation and size. The user inputs the location, size and orientation of each geometric element in order to differentiate one character from another. If the input method used large elements such as radicals, that do not vary much in orientation, the value of the information input would be limited.

4. Slightly curved lines are treated as strait lines. It would be very difficult for users to distinguish between slightly curved lines and straight lines.

5. Strongly curved lines are ignored. Straight lines can be input very easily with this input device, but strongly curved lines would be difficult to input.

To meet the above requirements, the proposed invention employs the six symbols shown in FIGS. 2a-2f as the preferred character elements to be used for Chinese in this input device and input system.

The six character elements shown in this invention have been selected on the above principles. The definition of the character elements, and even the use of additional elements, may be necessary during the optimisation of the input device.

The Preferred Input Device

The preferred input device of this invention is intended to be connected to a computer or other language processing system, in place of the standard keyboard. While this preferred input device provides outstanding performance to the character input method to be described below, it should be appreciated that other appropriate devices can also be used without loss of generality.

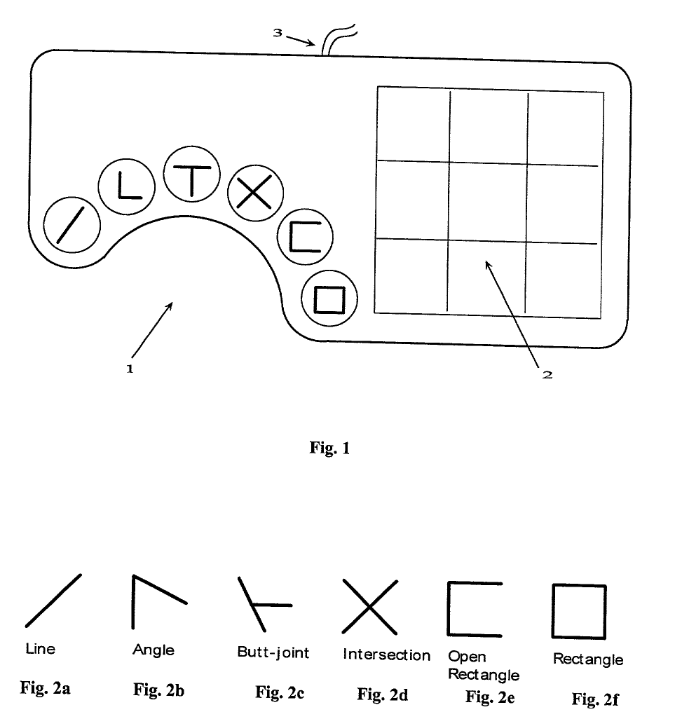

The preferred input device, see FIG. 1, comprises three main components:

1. Six conventional key switches used to select character elements of characters.

2. A input grid that can sense and record two simultaneous finger taps.

3. A software program that includes a database of character attributes.

Input Grid

The input device incorporates a flat, square input grid, that can detect two simultaneous finger taps. See FIG. 1(2).

Six Keys Used to Select Character Elements

The input device also incorporates a set of six keys marked with symbols representing character elements found in Chinese or other non alphabet-based characters, see FIG. 1(1). When one of the six keys is activated, it controls which of the six character elements is input by the input device.

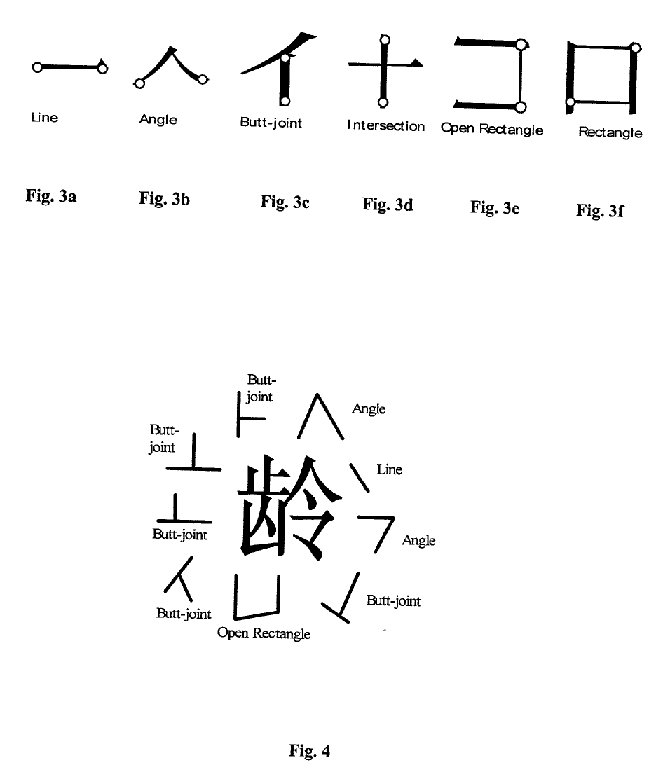

The set of character elements used for Chinese characters is shown in FIGS. 2a-2f. Typical examples of character elements taken from the GB character set are shown in FIGS. 3a-3f. Definitions of the character elements are shown in Table 1.

The Input Device Software, Including the Database

In order to use this input device with a computer, or other language processing system, a set of Chinese or other non-alphabet-based characters must be present. Common sets include GB simplified Chinese, GBK simplified and traditional characters, Big5 traditional Chinese and Unicode Chinese.

A database that forms part of the input device contains, for every character in a specific character set, a record of all of its character elements, with the coordinates of the two input points on each.

Each time the user inputs a character element, data comprising the type of character element, and its coordinates is sent from the input device to the database. The software program searches the database and identifies a subset of characters that contain a character element with the same coordinates.

The Input Method

Chinese characters in their modern form are constructed predominantly of straight lines, and nearly-straight lines. When these straight and nearly straight lines join or cross, they create very simple character elements, that occur with extremely high frequency throughout all Chinese characters. The most common of these elements, one or more of which occur in every Chinese character, include the preferred set used in the input method:line, angle, butt-join, intersection, open rectangle, and rectangle.

FIGS. 2a-2f, shows the preferred character elements which can be used in the process of uniquely identifying a character from a database of characters. These symbols are selected because of their frequent appearance in the present language of interest, namely, Chinese.

In the present invention, the user is able to specify the location of each character element in the character by simultaneously tapping the input grid with two fingers in the corresponding position.

When the user inputs the location of a character element, it is transformed from being an extremely common attribute of the character to an extremely rare attribute. Character elements vary enormously in respect of their location, size and angular orientation. When a database is searched to find characters possessing a character element of a specific location, size and angle, only a small number of characters, 20-60 may be identified. If the user enters two character elements, the database search will usually yield only one character that matches both character elements.

It should be appreciated that the invention can be used equally well for other types of character-based language systems. For example, by using different characterizing symbols in language systems where the characters are constructed differently from Chinese. For example, instead of using symbols based on straight lines, components having curved parts could be used.

Visual Approximation

In the description below, the present invention will be explained by reference to a preferred set of character elements: the line, butt-joint intersection, open rectangle, rectangle. Although the input method is based on identifying these elements in characters, the identification process is always a visual approximation. For example, many lines in Chinese characters are curved, but if the curve is small, we can regard them as straight and identify them as part of an angle, a line, or one of the other elements.

Often, a character element may be distorted, or shrouded by nearby parts of the character, so that identification becomes ambiguous. Any kind of uncertainty associated with identification of the character elements will reduce the speed of language input and cause errors. To minimise this problem, the user of this input device must be provided with rules for identification and input of character elements.

Use of the Character Elements

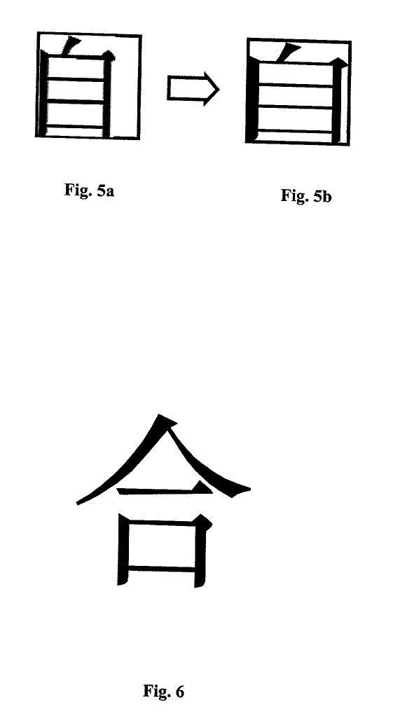

The use of the character elements will now be further explained by reference to FIG. 4 in which a Chinese character “ [symbol] ” is shown. This Chinese character “ [symbol] ” consists of three discrete elements, namely; “ [symbol] ”, “ [symbol] ”, “ [symbol] ”. If the slight curvature of some lines is ignored, then the character elements of this character can be represented very easily by three of the symbols in this invention, namely, 1b, 1a, and 1f.

FIGS. 3a to 3f, illustrates the two points on each of the character elements that show the location of the finger taps used to input them to the input grid.

Description of Input Sequence

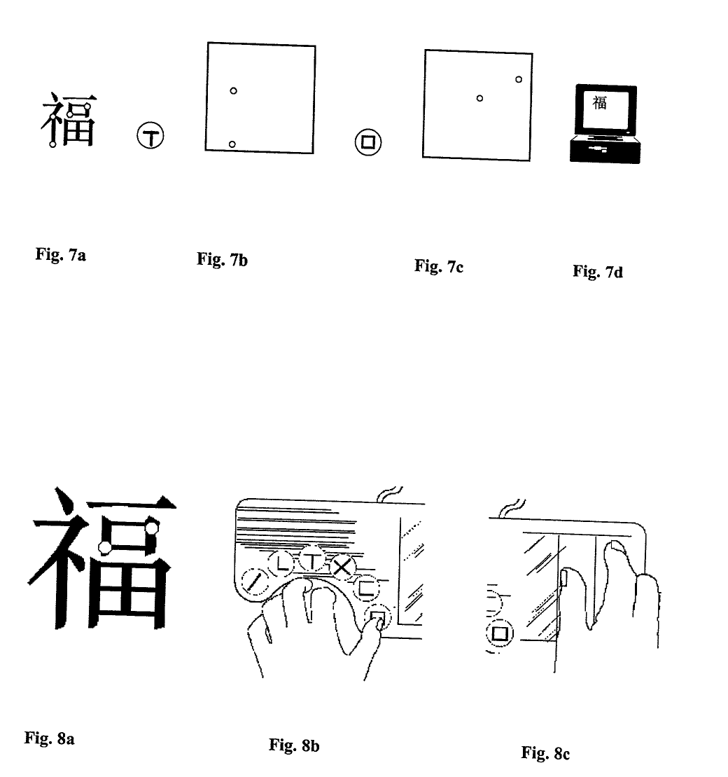

FIGS. 7a to 7d, shows the two stages by which the input device user inputs the character “ [symbol] ” as a demonstration of the present invention. During normal Chinese language input, the two-stage process takes place in a faction of a second.

(1) The user first identifies in the character two character elements, from the set of six that are represented by the symbols in FIGS. 2a-2f. The user may enter any character element and the database that forms part of the input device will use the information to identify the desired character. However, poor choice of character elements can slow the input process, and therefore the input device supplier will provide guidelines to the choice of character element. In this case, we shall assume the user first selects 2c, the butt-joint.

(2) The user presses the key with the butt-joint, symbol, and this information is sent to the database.

(3) The user taps two fingers of one hand on the input grid, to specify the location of the butt-joint. By using two points to specify the location of the butt-joint, the user is specifying the location, size and angle of the butt-joint in the “ [symbol] ” character. The input grid detects the finger taps, and generates the coordinates of each tap: (X₁Y₁, X₂Y₂). This information is sent to the database.

(4) The user cannot specify the location of the butt-joint with perfect accuracy and is likely to make a small error. Therefore, when the database receives the information, it will modify the coordinates using an error tolerance of, for example, ±15%.

(5) When the database receives the information from the input device that the user is inputting a butt-joint, with the coordinates (X₁Y₁, X₂Y₂), it searches all the character records to identify the character that is indexed as having a butt-joint in that exact location.

(6) It is most likely that, by chance, several characters have a butt-joint in a similar location to the “ [symbol] ” character. In this case, the database software temporarily retains a record of the characters that contain a similar butt-joint, in the computer's Random Access Memory. It does not matter if the database discovers many characters with the same butt-joint, provided that the “ [symbol] ” character is among those found. The user of the input device is not aware of the temporary storage of the subset of characters.

(7) Referring to FIG. 7C, the user presses the key with the symbol and taps the input grid with two fingers to specify the coordinates of the rectangle in the character.

(8) The database searches for a second time, but this time, it only searches the subset of characters that has already been retrieved and held in computer memory. It is most likely that only one character, that is “ [symbol] ”, will contain the rectangle element, so this character is displayed on the computer screen, FIG. 7d.

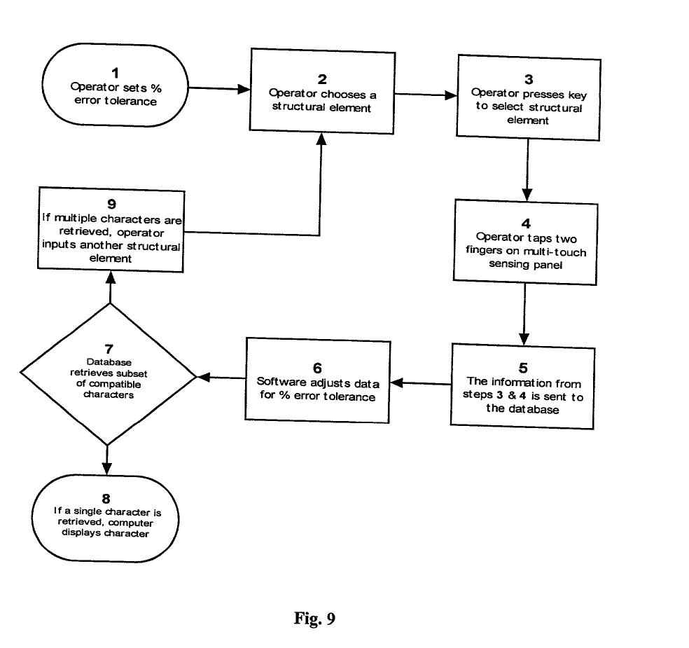

FIGS. 8a-8c, shows the use of the user's hand to operate the symbol key for “rectangle” and the use of a hand to specify the location of this character element in the character by tapping the input grid.

The input process described above can be used for the retrieval of all Chinese characters. Of course, the computer must have the correct character set, and the database software must be programmed for use with that character set.

Some Chinese characters may be retrieved by input of a single character element, while in other cases, three character elements must be entered. For most characters, retrieval will result after two character elements have been input

A flow chart explaining the present invention which is essentially a summary of the present invention is shown in FIG. 9.

Aspect Ratio Compensation

Chinese characters are often written by students in a ruled grid. Characters are regarded as approximately “square” and the grid of rules is used with a system called ‘Kau Gung Grid’ ( [symbol] ) to facilitate the correct positioning of strokes and radicals within the characters.

In the present invention the input device user locates each character component within a square input grid that corresponds precisely with the square outline of the character.

Although most characters are square, a few characters are wider, or narrower than the square shape, for example, these three characters are narrow “ [symbol] ”, “ [symbol] ”, “ [symbol] ”. This means that the input grid is too wide to represent some characters and too high to represent other characters. If a user tried to locate character elements of wide or narrow characters in the square input grid, the user would not be sure where the top and bottom, or left and right edges of the character should be located, and errors would result.

To eliminate this problem, during original programming of the database, wide or narrow characters are digitally “re-mapped” (distorted to become exactly square) before input of their character elements. As a result, users using this input device may always use the full area of the input grid, as if all characters were perfectly square in shape.

Example of Character Exploded

In FIG. 4, the rather complicated Chinese character “ [symbol] ” is shown, together with some of the character elements that can be used for input of this character. The user can choose to input any of the character elements shown. However, a skilled user will possess the knowledge required to select character elements that differentiate the character from any similar characters and therefore can ensure that the character is retrieved from the database after the minimal input effort.

User Error Compensation

When character elements are entered to the input grid, skill is required to locate them correctly, so errors are made that vary between users. If inaccurate data is sent to the database, it will fail to retrieve the correct characters. To compensate for this error, the coordinate values for character elements are modified with a “tolerance” value for user error. For example, if the X-coordinate of a character element is 20 mm, and the user error compensation is set to 10%, &hen the value is modified to 20±10%.

When the database searches for that character element, it will not search for 20 mm, but for a range of values between 20±10%. This means that more characters will be found by the database search. However, even if the user made a slight error in inputting the coordinates, the database will still find the correct character. The user error compensation can be adjusted as a software function.

New users make relatively large errors, and need to set the user error level to a high value. When the user inputs a character element, a larger subset of characters will be retrieved, and this may mean that more character elements need to be input in order to retrieve the correct character. Experienced users make smaller errors, and can set the user error level to a low value. When the user errors level is set to a low value, the subset of characters retrieved is small, and fewer character elements need be input to retrieve the correct character.

Alternative Embodiment: Three Finger Tap Version

A second embodiment of the invention comprises the preferred embodiment as described above, but incorporating a input grid that can discriminate three simultaneous finger taps and output the coordinates.

The use of three fingers to simultaneously tap the input grid enables geometry components such as the angle, the butt-joint and the open rectangle, to be specified more accurately using three touch points, and this can speed character retrieval, at the expense of a more difficult finger movements during input. The datum points for the character elements that use three finger taps may be selected to meet the design objectives of the embodiment.

Tables A summary of the preferred character elements together with a description of their particular features, as well as the defining points are set out in Tables 1 and 2.

TABLE 1
Definitions of character elements

| | |
|---|---|
| Line | A straight line with one or both ends unconnected |
| Angle | Any angle formed between two lines |
| Butt-joint | Two stokes forming a butt joint any angle |
| Intersection | The intersection of two lines at any angle |
| Open | Three sides of a rectangle with at least one unconnected end |
| Rectangle | |
| Rectangle | A rectangle irrespective or external connections |

Note: Character elements may have any angular orientation in characters

TABLE 2
Datum Points to input on Character elements

| | |
|---|---|
| Line | The two end-points |
| Angle | The end-points of each line away from the apex |
| Butt-joint | Foot of stem & junction of stem and crossbar |
| Intersection | Equidistant points on right-learning stroke |
| Open | The two corrier points |
| Rectangle | |
| Rectangle | The end-points of the right-leaning diagonal |

While the improved character input method described above has been described by reference to the six symbols set out in FIGS. 2a-2f, it would be appreciated that some or all of the symbols may be selectively used and other appropriate symbols of a similar nature or structure may also be utilized without loss of generality. Also, while the present character input method has been explained by reference to the simultaneous tapping of both-fingers on a square input-grid, it should be appreciated that the inputting is not limited to the simultaneously tapping of two fingers and can be input by sequential positioning of the fingers or other appropriate input devices or, alternatively, the symbol definition may be by simultaneously tapping of more than two fingers. Furthermore, while a square input grid has been described above, it should be appreciated that the inputting grid can be made into a rectangular or other appropriate shapes without affecting the scope of the invention.

While the input device of the present invention has been explained by reference to a discrete input device with a specific layout of the symbol keys and the input grid, it should be appreciated that the symbols marked on the surface of the input keys may be arranged in a different sequence or may comprise a selection of the available symbols or include additional keys. In addition, the input device may be integrated into another apparatus as a part thereof. Of course, the layout of the keys as well as the positions of the grids are only provided for illustration and can be arranged in other appropriate ways. While the present invention has been explained and illustrated by reference to preferred embodiments of methods and devices described above, it should be appreciated that those examples are only provided to assist understanding of the present invention and should not be construed as limiting to the scope of the invention. The scope of the invention of course covers deviation or modifications which are trivial or obvious to persons skilled in the art.

1. A method of inputting a character into an electronic device having a database of characters including the following steps:
(1) selecting a character element or other characterizing symbol from a plurality of preselected symbols, said characterizing symbol being visually similar or equivalent to at least a portion of said character;
(2) entering said characterizing symbol into said electronic device by specifying the position, orientation and/or relative size of components of said characterizing symbol by means of two fingers simultaneously tapping in an input grid; and
(3) performing steps (1) and (2) a number of times such that the database receives sufficient information to uniquely identify the said character.

2. A method of claim 1, wherein said characterizing symbol is entered into said electronic device through a square input grid at a location and orientation relative to the square grid that is identical to the location and orientation of the character element relative to the said character.

3. A method of claim 2, wherein said input grid bears a grid of lines intended to assist the user in locating his hand during input.

4. A method according to claim 1, wherein said characterizing symbols can be defined by using two definitive points on said input grid. Entering said characterizing symbol in to said electronic device by specifying the position, orientation and/or relative size of components of said characterizing symbol by means of two fingers simultaneously tapping in an input grid.

5. A method according to claim 1, wherein said characterizing symbols include one or a combination of the symbols: [symbol] [symbol]
regardless of the size and orientation and minor variation of said symbols.

6. A method according to claim 1, further including adjusting the aspect ratio of a character to near unity for specifying its physical characteristics both in the database and in the input grid.

7. A method according to claim 1, wherein said method includes search by a processing means for characters having said symbol and said physical characteristics of said symbol.

8. A character input device for an electronic device including a plurality of input selections corresponding to a plurality of input selectable characterizing symbols and an input grid on which the relative size, orientation and/or position of said selected symbol can be defined and input into said electronic device.

9. A device according to claim 9, wherein said selectable characterizing symbols include one or some of the following symbols:

[symbol]

[symbol]

10. A device according to claim 8, wherein said input grid includes a square panel having associated with it the means of detecting the locations of two simultaneous finger touches on its surface.

11. An input device according to claim 8, wherein said selected characterizing symbol can be entered through the input grid by means of two fingers simultaneously tapping in an input grid.

12. An input device according to claim 8, wherein the identify of said symbol as well as the associated physical characteristic are sent from said device to an electronic processing means.

13. A device according to claim 8, wherein said input grid includes a touch-type sensor pad.

14. An input device according to claim 8, wherein said selected characterizing symbol can be entered through the input grid using two definitive points.

15. A method of inputting a character into an electronic device having a database of characters including the following steps:
(1) selecting a characterizing symbol of said character from a plurality of pre-selected symbols, said characterizing symbol being visually similar or equivalent to at least a portion of said character;
(2) entering said characterizing symbol into said electronic device by specifying the position, orientation and/or relative size of components of said characterizing symbol;
(3) performing steps (1) and (2) one or more times until said character has been selected.

16. A method of claim 15, wherein said characterizing symbol is entered into said electronic device through a substantially square input grid.

17. A method of claim 15, wherein said physical characteristics including the relative size of components, position and/or orientation of said characterizing symbols are input with reference to a grid in which the character to be selected is squarely fitted.

18. A method according to claim 15, wherein said characterizing symbols can be defined by using two definitive points on said input grid.

19. A method according to claim 15, wherein said characterizing symbols include one or a combination of the symbols [symbol] [symbol]
regardless of the size and orientation and minor variation of said symbols.

20. A method according to claim 15, wherein said method includes search by a processing means for characters having said symbol and said physical characteristics of said symbol.

21. A database of characters wherein the characters in said database are categorized according to a plurality of symbols and the characters are indexed according to the physical characteristics, including size, orientation and/or position, associated with each symbol with reference to the physical locations of said symbols or a visual equivalence of said symbols in said characters.
